(19) United States
(12) Patent Application Publication
(10) Pub. No.: US 2014/0234108 A1
(43) Pub. Date: Aug. 21, 2014

(54) ROTOR WITH A CURVED ROTOR BLADE FOR A WIND POWER PLANT

(71) Applicant: Thomas Nägler, Lubeck (DE)

(72) Inventor: Thomas Nägler, Lubeck (DE)

(73) Assignee: DeWind Europe GmbH, Lubeck (DE)

(21) Appl. No.: 14/123,058

(22) PCT Filed: May 31, 2012
(86) PCT No.: PCT/EP2012/060312

§ 371 Date: Apr. 4, 2014

(30) Foreign Application Priority Data
May 31, 2011 (EP) 10 2011 050 777.9

(51) Int. Cl. F03D 1/06

(52) U.S. Cl. CPC F03D 1/0633
USPC 416/204 R; 416/243

(57) ABSTRACT

In order to optimise a rotor (1) for a wind turbine (2), comprising a hub (6) which is rotatable about an axis of rotation (15) and a number of rotor blades fixed to the hub (6), at least one rotor blade having at least one curved portion (8) having a curve in the upstream direction, so as to increase the performance of wind turbines (2), it is proposed for a base portion (7) of the curved rotor blade (5), extending from the hub end, to be arranged with the longitudinal axis (14) thereof at a wind correction angle (11) in the upstream direction to a plane (16) orthogonal to the axis of rotation (15).

The present invention relates to a rotor for a wind turbine, comprising a hub which is rotatable about an axis of rotation and a number of rotor blades fixed to the hub, at least one rotor blade having at least one curved portion having a curve in the upstream direction.

The present invention equally relates to a curved rotor blade comprising at least one curved portion having a curve in a longitudinal extension for use with a rotor according to the present invention.

In the prior art, the electrical outputs which can be achieved by wind turbines are limited. The performance of wind turbines, in other words the electrical output which they can achieve, is heavily dependent on the profile of the rotor blades thereof. The profiles are shaped aerodynamically, in such a way that air flowing around them creates lift. Further, the surface areas thereof are selected to be as large as possible, so as likewise to increase the lift. The maximum lift in the partial load and nominal load range is a limiting factor for the performance of wind turbines. The maximum lift which can be achieved by the rotor blades depends on the profile and the constructional arrangement of the components of a wind turbine with respect to one another, and is achieved under specific operating conditions. Thus, the distance between the rotor blades and the tower influences the maximum achievable lift, since a build-up of air in the air flowing around the wind turbine forms between the rotor blades and the tower. A decisive operating parameter is the absolute inflow speed of the wind onto the wind turbine, in other words the speed at which the wind flows into the wind turbine. The limit of this operating parameter is achieved in an interplay with the build-up of air when the flow is separated from the rotor blade. As a result, the lift immediately decreases. This results in power losses and potentially in high mechanical loads on the wind turbine. Previous attempts to increase the maximum achievable lift primarily involved optimising the profiles used. The feasible size of profile surface areas places a further limit on the performance of wind turbines. The profile surface areas increase as a function of the rotor blade length. Using very long rotor blades leads to the risk of them touching the tower during operation. For this purpose, EP 1 019 631 B1 proposes configuring the rotor blades used to be curved in the upstream direction. This document also considers inclining the nacelle upwards from the horizontal orientation in the rotor direction, in such a way that the rotor blades are further away from the base of the tower. The drawback is mentioned that this results in a highly aesthetically unpleasing appearance, which the community does not find to be acceptable.

A drawback of the device known from EP 1 019 631 B1 is that the curvature of the rotor blades is only suitable for ensuring the required distance between the rotor blades and the tower for wind turbines of a particular size, since excessive curvature of the rotor blades is found to be aerodynamically unfavourable and can even lead to stalling. The curved rotor blades of EP 1 019 631 are therefore not conducive to an improvement in the performance of wind turbines.

The object of the present invention is therefore to optimise a rotor for a wind turbine, comprising a hub which is rotatable about an axis of rotation and a number of rotor blades fixed to the hub, at least one rotor blade comprising a curved portion having a curve in the upstream direction, and a curved rotor blade of the type mentioned at the outset in such a way as to increase the performance of wind turbines.

The object as regards the rotor is achieved according to the invention by a rotor of the type mentioned at the outset in which a base portion of the curved rotor blade, extending from the hub end, is arranged with the longitudinal axis thereof at a wind correction angle in the upstream direction to a plane orthogonal to the axis of rotation. According to the invention, the wind correction angle and the curvature of the rotor blades in combination advantageously reinforce the orientation of the wind turbine in the upstream direction. In this context, the combination of rotor blades which are curved in this manner and the wind correction angle generate more lift than with rotor blades which do not have a curve or are not arranged at a wind correction angle to the orthogonal plane of the axis of rotation, or have neither of the features of the combination. The wind correction angle may advantageously be between three degrees and four degrees, in particular three-and-a-half degrees. However, smaller angles, for example 0.5°, and larger angles, for example 5°, are also possible, depending on the rotor blade length and the rotor blade configuration. Also, limits on an increase in the size or length of the disclosed rotor blades only occur later than in conventional rotor blades, since the upstream orientation of the rotor ensures a greater distance from the tower, in particular from the base of the tower. In this context, conventional rotor blades should be understood as those rotor blades which extend straight over the length thereof when there are no wind forces on these rotor blades. The increase in the size or length of the rotor blades, and thus of the tower, is a deciding factor for the performance of wind turbines, since in higher layers of the air the turbulence induced by the constitution of the surface of the ground is much smaller, and the wind blows much more strongly and uniformly. The performance of wind turbines is therefore increased. The curved rotor blade may advantageously be approximately 45 metres long and be positioned at a wind correction angle of three-and-a-half degrees in the upstream direction. However, other rotor blade lengths are also feasible. In this context, the wind correction angle may also be in the range of virtually 0° to 5°, the wind correction angle being selected as a function of the rotor blade length and the rotor blade configuration.

In a further advantageous embodiment of the rotor according to the invention, the curved rotor blade may be configured in such a way that, under the effect of a flow at a given inflow speed, preferably the upper operating inflow speed, the curve is substantially compensated. Herein, the inflow speed is understood as the speed of the wind at which the wind flows into the rotor or the rotor blades during operation. Herein, the upper operating inflow speed is understood, by definition, as the speed of the wind at which the curved rotor blades no longer have a curve as a result of the incident wind forces. According to the invention, the curved rotor blades are constructionally configured in such a way that in the absence of wind, in other words at a negligible inflow speed, they are in the constructionally predetermined shape thereof, and when wind flows in at the upper operating inflow speed, the curvature of the curved rotor blades is compensated by the wind forces. In this case, the curved rotor blades are positioned on what is known as a zero line. At a nominal inflow speed, which is below the upper operating inflow speed, the curved rotor blades are positioned deflected between the constructionally predetermined shape and the zero line as a result of the wind forces. Herein, the nominal inflow speed is understood as the wind speed from which it is possible to achieve the nominal power of a wind turbine.

The constructional configuration of the curved rotor blades may be provided in any manner familiar to a person skilled in the art, for example by varying the material properties and/or the mechanical construction. The materials have to be selected in such a way that they make elastic deformation possible, and therefore no plastic deformation occurs. The construction has to take into account the respective external influencing factors on the basis of the materials. A wind turbine which is to be set up inland is subject in part to quite different influencing factors from an offshore wind turbine. The present invention advantageously makes it possible for the nominal power of a wind turbine to be achievable over a wider band of wind speeds, since the curved rotor blades only deform in an aerodynamically unfavourable manner at higher wind speeds than conventional rotor blades. This increases the performance of wind turbines.

In one advantageous embodiment of the invention, the curved rotor blade may have a width which is variable over the length thereof. As a result, the curved rotor blade can on the one hand compensate strength problems brought about by aerodynamically necessary twists in the construction of the curved rotor blades, and on the other hand reduce eddies particularly well in relation to the aerodynamic configuration thereof. The curved rotor blade may advantageously be approximately 2000 mm wide at the hub end thereof and approximately 3500 mm wide at the widest point thereof at a length of approximately 45 metres. In further constructional embodiments, however, the widest point may be of different dimensions, for example up to 5500 mm.

In one advantageous embodiment of the invention, the base portion may be formed extending at least up to the length of the curved rotor blade assigned to the greatest width. On the one hand, this makes an aerodynamically favourable inflow onto the rotor possible about the hub, and on the other hand, the constructional design of the base portion leads to a high strength of the rotor blade as a whole, meaning that the nominal power is achieved over a wider band of wind speeds than in wind turbines having conventional rotor blades. The high strength of the base portion makes it possible for a smaller deformation to occur as a result of the wind than in conventional rotor blades. As a result, longer and larger rotor blades can be used, and this in turn increases the performance of wind turbines.

In a further advantageous embodiment of the invention, the curved portion may be arranged adjacent to the base portion. A direct connection of the curved portion to the base portion has been found to be aerodynamically advantageous, since there is less mutual influence between the tower and the curved rotor blade than when a conventional rotor blade is used. As a result, more lift is generated at the rotor blades, and this in turn increases the performance of wind turbines.

In a further advantageous embodiment of the invention, the curved portion may be formed extending up to a portion of the curved rotor blade remote from the hub. This leads to a greater distance between the curved rotor blade and the tower, in other words less build-up of air and less mutual influence than when a conventional rotor blade is used. This too means that the rotor blades can be constructed to be larger or longer than when a conventional rotor blade is used, and this likewise increases the performance of wind turbines.

In one advantageous embodiment of the invention, a substantially non-curved portion may be arranged adjacent to the curved portion in the direction away from the hub. In this context, the longitudinal axis of the base portion and a longitudinal axis of the non-curved portion adjacent to the curved portion may in particular be at an angle of approximately one degree with respect to one another. In this context, this angle and the wind correction angle may advantageously be in a ratio of between one to two and one to four. This embodiment has also been found to be aerodynamically favourable. This increases the lift of the rotor blades, and the performance of wind turbines is also increased.

In one advantageous embodiment of the invention, the curved rotor blade may have a further curved portion. This embodiment is also particularly aerodynamically favourable. In this context, the curve relates to a further curvature of the curved rotor blade in the upstream direction. This increases the lift of the rotor blades and improves the performance of wind turbines.

In a further advantageous embodiment of the invention, some or all portions of the curved rotor blade may substantially consist of a material containing carbon fibres and/or glass fibres. A material of this type has the advantage that it can be shaped particularly well and is of a high rigidity. The good malleability of the material makes the curved rotor blade simple to produce. The embodiment of the curved rotor blades using a material containing carbon fibres also particularly advantageously makes it possible to implement, in a defined manner, a calculated bend line, which has been found to be particularly advantageous for the aerodynamics of the profile of the curved rotor blades at wind speeds below the upper operating inflow speed, and which no longer has a curve when the upper operating inflow speed is reached. The high rigidity of the material further means that it is still possible to operate a wind turbine having curved rotor blades even at higher wind speeds than for a wind turbine having conventional rotor blades. The high rigidity and the low weight also make it possible to construct larger rotor blades than with other materials, since the use of carbon fibres means that the rotor blades can be configured with a larger surface area at the same mass.

In a further advantageous embodiment of the invention, some or all portions of the curved rotor blade may substantially consist of a material containing carbon fibres and/or glass fibres. A material of this type can likewise be shaped well, and is light and favourable for production and machining. It is also possible to implement a required rigidity of the rotor blade in a particularly constructionally advantageous manner.

In one advantageous embodiment of the invention, the curved rotor blade may comprise attachment portions at a hub end for attaching the curved rotor blade to the hub, a surface normal of an attachment plane determined by the attachment portions being at the wind correction angle to the plane orthogonal to the axis of rotation. These attachment portions serve to fix the rotor blade to the hub. This produces a clearly defined contact surface between the hub and the rotor blade, and this surface makes it possible to fix the rotor blades at a wind correction angle. The rotor blades can therefore be orientated in accordance with the constructional specifications in such a way that the curvature of the curved rotor blades is exploited in an aerodynamically favourable manner and a maximum lift is achieved. This too improves the performance of wind turbines. Further, this delineates one possible way of achieving the wind correction angle. In the case of newly constructed rotor blades, this is one possibility for integrating the wind correction angle into them from the outset.

In one advantageous embodiment of the invention, an angle element may be provided between the hub and the curved rotor blade, and comprises a face for attachment to the curved rotor blade and a further face for attachment to the hub, the surface normals of the two faces being at the wind correction angle with respect to one another. An angle element is particularly suitable for retrofitting to wind turbines. In this way, the wind correction angle of the rotor blades to the axis of rotation can be changed. Advantageously, because of the angle element according to the invention, a modification to the attachment portions of the rotor blades or a change to the hub is not required. An angle element is also simple to mount and does not require any readjustment on the part of the assembly personnel by comparison with conventional constructions. Therefore, this can also retroactively optimise the aerodynamic properties of the rotor blades in the wind and increase the lift.

In one advantageous embodiment of the invention, the hub may comprise hub attachment portions for attaching the hub to the curved rotor blade, a surface normal of a hub attachment plane determined by the hub attachment portions being at the wind correction angle to the plane orthogonal to the axis of rotation. The hub attachment portions make it possible to arrange the rotor blade and the hub in such a way with respect to one another that the desired wind correction angle is achieved and the aerodynamic profile is advantageously flowed into. This also increases the performance of wind turbines.

The object as regards a curved rotor blade is achieved by a curved rotor blade comprising at least one curved portion having a curve in a longitudinal extension for use with a rotor according to the present invention, in which the curved rotor blade comprises attachment portions at one end for attaching the curved rotor blade to a hub of a rotor of a wind turbine, a surface normal of an attachment plane determined by the attachment portions being at a wind correction angle to the longitudinal axis in the direction of the curve. A curved rotor blade of this type has been found to be particularly aerodynamically advantageous. It is also particularly advantageously suitable for retrofitting on existing wind turbines so as to improve the performance of these wind turbines. In this context, the rotor blade which is curved in accordance with the invention, together with a pre-existing hub, forms an advantageous rotor in which the curved rotor blades are arranged at a wind correction angle in the upstream direction to a plane orthogonal to the axis of rotation.

The object as regards a curved rotor blade is equally achieved by a curved rotor blade in accordance with the preamble of claim 13, which is configured in such a way that the curve is substantially compensated under the effect of flow at a given inflow speed, preferably an upper operating inflow speed, of the wind turbine in operation. As a result, it is possible to operate the wind turbine at higher wind speeds than for wind turbines having conventional rotor blades. It is also particularly advantageously suitable for retrofitting on existing wind turbines so as to improve the performance of these wind turbines. In this context, the curved rotor blade, together with a pre-existing hub, forms an advantageous rotor.

In one advantageous embodiment of the rotor blade according to the invention, a curved rotor blade may comprise attachment portions at one end for attaching the curved rotor blade to a hub of a rotor of a wind turbine, a surface normal of an attachment plane determined by the attachment portions being at a wind correction angle to the longitudinal axis in the direction of the curve. This makes it possible to orientate the curved rotor blade at the wind correction angle in such a way that it is flowed onto in an aerodynamically favourable manner. It is also particularly advantageously suitable for retrofitting on existing wind turbines so as to improve the performance of these wind turbines. In this context, the curved rotor blade, together with a pre-existing hub, forms an advantageous rotor in which the curved rotor blades are arranged at a wind correction angle in an upstream direction to a plane orthogonal to the axis of rotation.

A preferred embodiment of the invention is described by way of example with reference to drawings, it being possible to derive further advantageous details from the individual drawings.

In this context, functionally equivalent parts are provided with like reference numerals.

In the drawings, in detail:

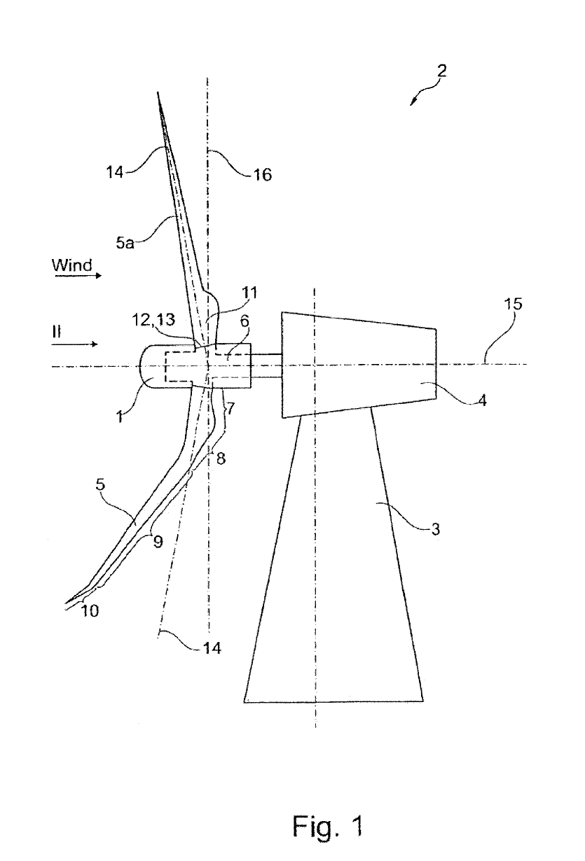

FIG. 1 is a schematic side view of a wind turbine comprising a rotor according to the invention, the lower half of the drawing showing a state in the absence of wind and the upper half of the drawing showing a state at an operating inflow speed;

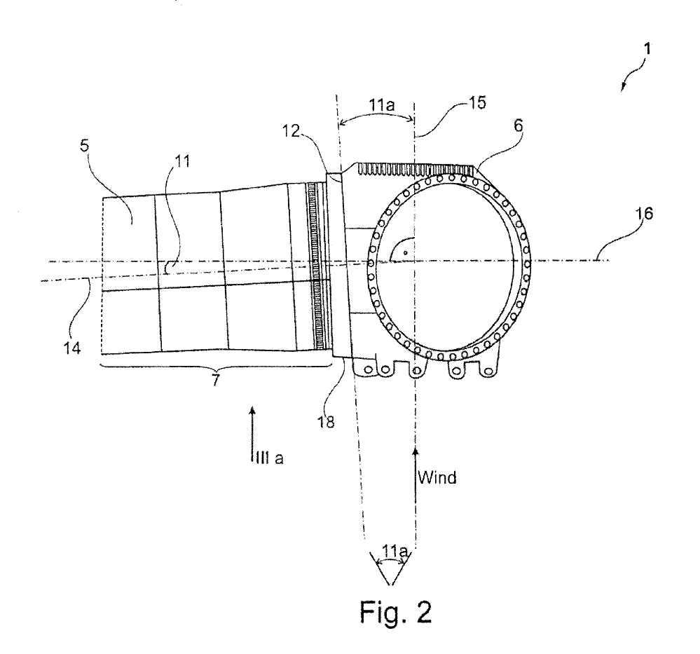

FIG. 2 is a front view, in the direction of the wind, of a rotor according to the invention for the wind turbine according to FIG. 1, comprising a hub and a part of a curved rotor blade;

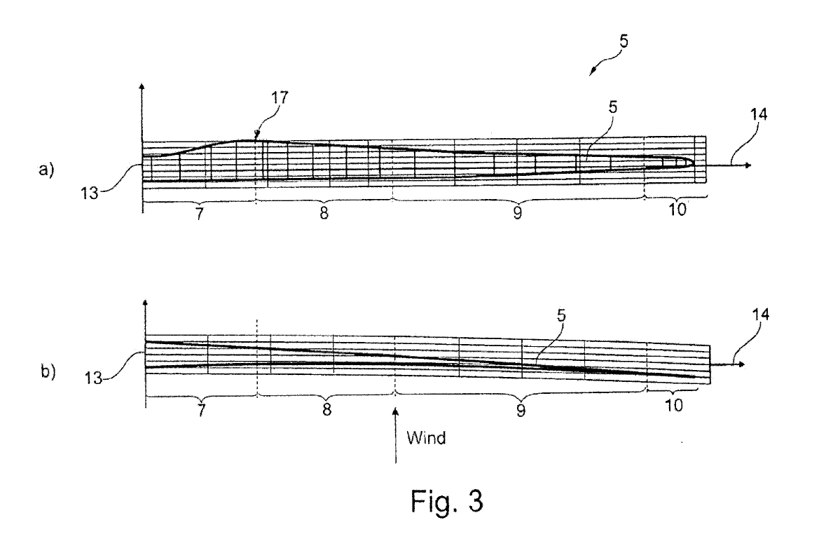

FIG. 3 shows a curved rotor blade according to the invention for a wind turbine according to FIG. 1, FIG. 3a) showing the curved rotor blade in the viewing direction of the arrow III a in FIG. 2, and FIG. 3b) being a front view of the blade of the curved rotor blade shown in FIG. 2;

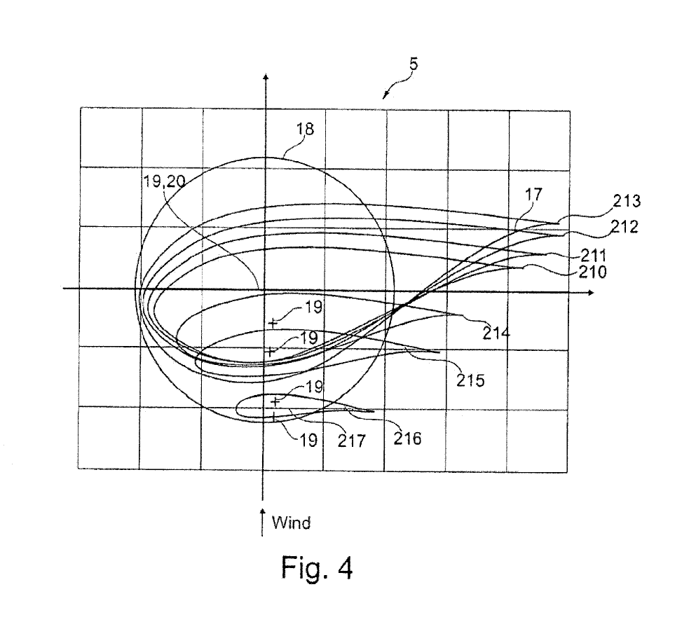

FIG. 4 shows profile cross-sections through the curved rotor blade according to the invention for different rotor blade lengths;

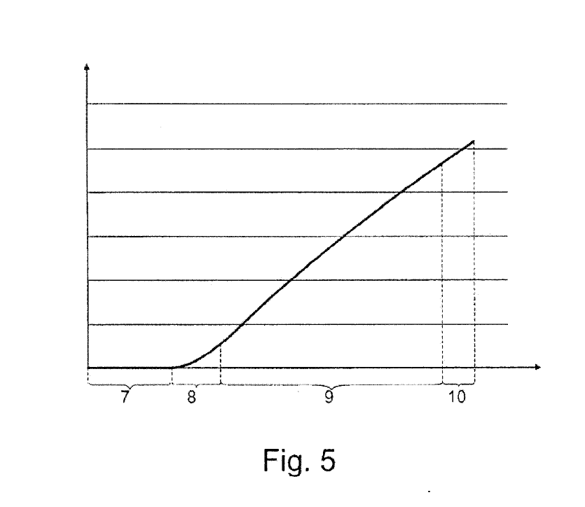

FIG. 5 shows the curve progression of the curved rotor blade according to FIG. 4 with respect to the rotor blade length in a spread coordinate system.

FIG. 1 is a schematic drawing of a wind turbine 2 comprising a rotor 1 according to the invention, the lower half of the drawing showing a state in the absence of wind and the upper half of the drawing showing a state at an operating inflow speed. The wind turbine 2 comprises a tower 3, a nacelle 4, the rotor 1, a hub 6 and a number of curved rotor blades 5, 5a. The nacelle 4 is arranged on the tower 3. The rotor 1 is arranged on the nacelle 4. The rotor 1 comprises two curved rotor blades 5, 5a and a hub 6. Further, an axis of symmetry of the tower 3, an axis of rotation 15 of the rotor 1 and a plane 16 orthogonal to the axis of rotation 15 can be seen in FIG. 1. An arrow also indicates the wind direction from which the wind flows onto the wind turbine 2. Further, a non-curved base portion 7 of the curved rotor blade 5, extending away from the hub end, can clearly be seen. Drawn through the base portion 7 is the longitudinal axis 14 thereof. The lower half of the drawing of the curved rotor blade 5 shows schematically a curve in the direction towards the wind of the curved rotor blade 5 in the absence of wind. The curved rotor blade 5 is therefore not deformed by the wind. The upper half of the drawing shows a curved rotor blade 5a, which is of an identical construction to the curved rotor blade 5 and onto which the wind flows at an upper operating inflow speed. At the upper operating inflow speed, the curvature of the rotor blade 5 is compensated by the effect of the wind in such a way that the rotor blade 5a extending in a straight line is present. The rotor blade 5a is therefore positioned on the longitudinal axis 14 of the base portion 7. Further, in this state it can be seen that the base portion 7 increases in width away from the hub 6. At the point where the curved rotor blade 5 is widest, the base portion 7 ends, and a curved portion 8 is attached. In turn, a substantially non-curved portion 9 is attached to the curved portion 8. A portion 10, which is remote from the hub and has a further curved portion, is attached to the non-curved portion 9. As can be seen particularly clearly from FIG. 1, the curved rotor blade 5 is not positioned in the plane 16 orthogonal to the axis of rotation 15 even at the upper operating inflow speed, since the curved rotor blade 5 is arranged at a wind correction angle 11 to the hub 6. The wind correction angle 11 is approximately three-and-a-half degrees. For the constructional implementation of the wind correction angle 11, the hub attachment portions are arranged on the hub 6 at the wind correction angle 11. However, there are a second and a third embodiment for achieving the wind correction angle 11. These embodiments are not shown in the drawings. In the second embodiment, an angle element is to be provided between the curved rotor blade 5 and the hub 6. This angle element comprises two attachment portions, the first of which is connected to the curved rotor blade 5 and the second of which is connected to the hub 5, and which are at the wind correction angle 11 with respect to one another. In the third embodiment, the curved rotor blade 5 comprises attachment portions which are orientated at the wind correction angle 11 to the orthogonal plane of the longitudinal axis 14 of the base portion 7. Unlike the angle element, which is particularly suitable for retrofitting on existing wind turbines 2, the two further options are preferably selected for new constructions. Finally, an arrow II also indicates the viewing direction of the wind turbine in FIG. 2.

FIG. 2 is a front view of a rotor according to the invention for the wind turbine according to FIG. 1, comprising a hub and a part of a curved rotor blade, in the viewing direction of the arrow II in FIG. 1. This is a detailed view of FIG. 1. The axis of rotation 15 is drawn through the hub 6. The longitudinal axis 14 of the base portion 7 is drawn through the curved rotor blade 5, of which only part of the base portion 7 can be seen. A further wind correction angle 11a can be seen between the axis of rotation 15 of the hub 6 and the hub attachment portion 12, and is equal to the wind correction angle 11. The angle is approximately three-and-a-half degrees. It can be seen that the wind correction angle 11 is given by the hub 6. When rotated about the axis of rotation 15, the hub attachment portion 12 covers a cone-shaped surface. It can further be seen from FIG. 2 that the hub 6 and the curved rotor blade 5 are interconnected using screw connections. However, weld, rivet and glue connections are also conceivable. It can also be seen from FIG. 2 that the hub 6 comprises threaded holes for a screw connection to the nacelle 4.

FIG. 3 shows a curved rotor blade according to the invention for a wind turbine according to FIG. 1, FIG. 3a) showing the curved rotor blade in the viewing direction of the arrow III a in FIG. 2, and FIG. 3b) being a front view of the blade of the curved rotor blade shown in FIG. 2. Both in FIG. 3a) and in FIG. 3b), a coordinate system with gridlines is provided for orientation. In FIG. 3a), the length of the curved rotor blade 5 is plotted on the x-axis and the width of the curved rotor blade 5 is plotted on the y-axis. From the hub end, on the left in view a), the width increases until a point of greatest width 17. This region from the hub end to the point of greatest width 17 is the base portion 7. A curved portion 8 is attached to the base portion 7. In turn, a substantially non-curved portion 9 is attached to the curved portion 8. A portion 10, which is remote from the hub and has a further curved portion, is attached to the non-curved portion 9.

FIG. 3b) is a view rotated through 90° from FIG. 3a), not looking onto the cross-section of the curved rotor blade 5. In FIG. 3b), the length of the curved rotor blade 5 is plotted on the x-axis and the thickness of the curved rotor blade 5 is plotted on the y-axis. The direction from which the wind flows onto the rotor 1 is also shown, and extends in the y-direction. It can be seen particularly clearly from FIG. 3b) that the base portion 7 transitions into a curved portion 8. It can further be seen that the curved rotor blade 5 is inclined upstream, in other words in the negative y-direction. Thus, the rotor blade 5 is deflected upstream at the tip thereof with respect to the x-axis by approximately half the thickness of the hub end.

FIG. 4 shows profile cross-sections 18, 210-217 through the curved rotor blade according to the invention at different rotor blade lengths. The width is plotted on the x-axis and the thickness is plotted on the y-axis. The wind direction from which the rotor 1 is flowed onto is also shown, and extends in the y-direction. The circle 18 shows the cross-section of the curved rotor blade 5 at the hub end thereof. The further profile cross-sections 210-217 show that the profile cross-section initially increases away from the hub up to a maximum value and subsequently decreases. This is indicated by the increasing numbering of the reference numerals thereof from 210 to 217. In this context, it can further be seen that the profile centre-point 19 becomes further away from the origin 20 of the coordinate system, which is coincident with the centre-point of the circle 18, in the negative y-direction with increasing distance from the hub. This clearly shows that the curved rotor blade 5 is curved upstream with increasing distance from the origin 20.

FIG. 5 shows the curve progression of the curved rotor blade according to FIG. 4 along the longitudinal deflection of the rotor blade. In the graphical representation, the length of the curved rotor blade 5 is shown on the x-axis and the curvature of the curved rotor blade 5 in the upstream direction is shown on the y-axis. In this context, the scales on the x-axis and y-axis are different. The curvature of the curved rotor blade 5 in the y direction is shown considerably enlarged. Proceeding from the intersection point of the x-axis and of the y-axis, a straight line can clearly be seen, followed by a curve. This straight line corresponds to the base portion 7. The curve shown corresponds to the curved portion 8 of the rotor blade 5 and merely extends over a short portion. In turn, a non-curved portion 9 is attached to the curved portion 8. This non-curved portion 9 ends at the portion 10 remote from the hub. This portion 10 remote from the hub is a further curved portion.

### LIST OF REFERENCE NUMERALS

1 rotor
2 wind turbine
3 tower
4 nacelle
5 curved rotor blade
5a curved rotor blade when flowed onto at upper operating inflow speed
6 hub
7 base portion
8 curved portion
9 non-curved portion
10 portion remote from the hub
11 wind correction angle
11a further wind correction angle
12 hub attachment portion
13 attachment portion
14 longitudinal axis
15 axis of rotation
16 orthogonal plane
17 point of greatest width
18 circle
19 profile centre-point
20 origin
210-217 profile cross-sections

1. A rotor for a wind turbine, comprising: a hub which is rotatable about an axis of rotation and a number of rotor blades fixed to the hub, at least one rotor blade having at least one curved portion having a curve in an upstream direction, wherein a base portion of the curved rotor blade, extending from the hub end, is arranged with a longitudinal axis ) thereof at a wind correction angle in the upstream direction to a plane orthogonal to the axis of rotation.

2. A rotor according to claim 1, wherein the curved rotor blade is configured in such a way that, under the effect of a flow at a given inflow speed, the curve is substantially compensated.

3. A rotor according to claim 1, wherein the curved rotor blade has a width which is variable over a length thereof.

4. A rotor according to claim 1, wherein the base portion is formed extending at least up to the length of the curved rotor blade assigned to the greatest width.

5. A rotor according to claim 1, wherein the curved portion is arranged adjacent to the base portion.

6. A rotor according to claim 1, wherein the curved portion is formed extending up to a portion of the curved rotor blade remote from the hub.

7. A rotor according to claim 1, wherein a substantially non-curved portion is arranged adjacent to the curved portion in a direction away from the hub.

8. A rotor according to claim 1, wherein the curved rotor blade comprises a further curved portion.

9. A rotor according to claim 1, wherein some or all portions of the curved rotor blade substantially comprises a material containing carbon fibres and/or glass fibres.

10. A rotor according to claim 1, wherein the curved rotor blade comprises attachment portions at a hub end for attaching the curved rotor blade to the hub, a surface normal of an attachment plane determined by the attachment portions being at the wind correction angle to the plane orthogonal to the axis of rotation.

11. A rotor according to claim 1, wherein an angle element is provided between the hub and the curved rotor blade, and comprises a face for attachment to the curved rotor blade and a further face for attachment to the hub, the surface normals of the two faces being at the wind correction angle with respect to one another.

12. A rotor according to claim 1, wherein the hub comprises hub attachment portions for attaching the hub to the curved rotor blade, a surface normal of a hub attachment plane determined by the hub attachment portions being at the wind correction angle to the plane orthogonal to the axis of rotation.

13. A curved rotor blade comprising at least one curved portion having a curve in a longitudinal extension for use with a rotor according to claim 1, comprising attachment portions at one end for attaching the curved rotor blade to a hub of a rotor of a wind turbine, a surface normal of an attachment plane determined by the attachment portions being at a wind correction angle to the longitudinal axis in the direction of the curve.

14. A curved rotor blade according to claim 13, wherein the curved rotor blade is configured in such a way that the curve is substantially compensated under the effect of flow at a given inflow speed of the wind turbine in operation.

15. A curved rotor blade according to claim 14, further comprising attachment portions at one end for attaching the curved rotor blade to a hub of a rotor of a wind turbine, a surface normal of an attachment plane determined by the attachment portions being at a wind correction angle to the longitudinal axis in the direction of the curve.

16. The rotor of claim 2, wherein the given inflow speed is an upper operating inflow speed.

17. The curved rotor blade of claim 14, wherein the given inflow speed is an upper operating inflow speed.
